(19) United States
(12) Patent Application Publication
(10) Pub. No.: US 2026/0187893 A1
(43) Pub. Date: Jul. 2, 2026

(54) INTERACTIVE PROCESSING SYSTEM, INTERACTIVE PROCESSING METHOD, INTERACTIVE PROCESSING DEVICE, AND PROGRAM

(71) Applicant: TOPPAN Holdings Inc., Tokyo (JP)

(72) Inventors: Tomoaki NAKAYAMA, Tokyo (JP); Ping ZHANG, Tokyo (JP); Shiori TADA, Tokyo (JP)

(73) Assignee: TOPPAN Holdings Inc., Tokyo (JP)

(21) Appl. No.: 19/546,458

(22) Filed: Feb. 23, 2026

Related U.S. Application Data
(63) Continuation of application No. PCT/JP2024/030707, filed on Aug. 28, 2024.

(30) Foreign Application Priority Data
Sep. 1, 2023 (JP) 2023-142500

(51) Int. Cl. G06T 13/40; G06F 40/40; G06T 13/80

(52) U.S. Cl. CPC G06T 13/40; G06F 40/40; G06T 13/80

(57) ABSTRACT

An aspect of the present disclosure is an interactive processing system having a processor that performs processing in response to a request from a user terminal device, the interactive processing system including: a personality information generation unit that generates personality definition text information representing the personality of a subject based on a plurality of personality factor parameters which influence the personality of the subject; and a response processing unit that generates response text information based on utterance information received from the user terminal device and the personality definition text information generated by the personality information generation unit.

### CROSS-REFERENCE TO RELATED APPLICATIONS

The present application is a continuation of International Patent Application No. PCT/JP2024/030707, filed on Aug. 28, 2024, which claims priority to Japanese Patent Application No. 2023-142500, filed on Sep. 1, 2023, the entire contents of each are incorporated herein by reference.

### TECHNICAL FIELD

The present disclosure relates to interactive processing systems, interactive processing methods, interactive processing devices, and programs.

### DESCRIPTION OF RELATED ART

As technologies using language models, for example, the technologies described in PTLs 1 and 2 are known.

The data generation method described in PTL 1 uses original data to construct prompts that serve as input sentences for a language model, supplies the prompts to the language model, and generates new data and label information for the new data from the language model, thereby generating sentences that are highly grammatical and natural. Further, PTL 1 describes that the prompts include a text type (e.g., reviews or articles) and a label type (e.g., emotion or classification).

In the information processing device described in PTL 2, when a user and an operator are talking by voice in real time, a user-side terminal estimates the operator's emotions, displays an avatar image expressing the estimated emotions within the ranges of levels of individual emotional expressions set by slider bars, and outputs the received voice data. The levels of emotional expressions are determined by the overall emotional expression level set by a slider bar.

### CITATION LIST

### Patent Literature

PTL 1: JP 2023-18624 A
PTL 2: JP 2023-72110 A

### SUMMARY

### Technical Problems

PTL 1 supplies the prompts that express emotions as label types (ratios of emotions) to a language model, and PTL 2 displays the levels of emotional expressions of an avatar, but it is difficult to provide an interactive avatar that operates by considering the personality and dialogue content of a specific person.

The present disclosure has been made in view of the above circumstances, and aims to provide an interactive avatar that operates by considering the personality and dialogue content of a specific person.

### Solutions to Problems

The present disclosure has been made to solve the above-mentioned problems, and an aspect of the present disclosure is an interactive processing system comprising: circuitry configured to receive a request from a user terminal, in response to the request from the user terminal generate personality definition text information representing the personality of a subject based on a plurality of personality factor parameters which influence the personality of the subject, and generate response text information based on utterance information received from the user terminal and the personality definition text information.

Another aspect of the present disclosure is an interactive processing method comprising:
generating personality definition text information representing the personality of a subject based on a plurality of personality factor parameters which influence the personality of the subject; and generating response text information based on utterance information received from a user terminal device and the personality definition text information.

Another aspect of the present disclosure is an interactive processing device comprising:
circuitry configured to generate personality definition text information representing the personality of a subject based on a plurality of personality factor parameters which influence the personality of the subject, and generate response text information based on utterance information received from a user terminal device and the personality definition text information.

Another aspect of the present disclosure is a non-transitory computer-readable storage medium storing computer-readable instructions thereon which, when executed by a computer, cause the computer to perform a method, the method comprising: generating personality definition text information representing the personality of a subject based on a plurality of personality factor parameters which influence the personality of the subject; and generating response text information based on utterance information received from a user terminal device and the personality definition text information.

### Advantageous Effects

According to an aspect of the present disclosure, an interactive avatar that operates by considering the personality and dialogue content of a specific person can be provided.

### BRIEF DESCRIPTION OF DRAWINGS

FIG. 1 is a block diagram illustrating a configuration example of an interactive processing system 1 according to an embodiment.

FIG. 2 is a diagram illustrating an outline of processing performed by the interactive processing system 1 according to the embodiment.

FIG. 3 is a diagram illustrating an example of processing performed on emotional parameters by the interactive processing system 1 according to the embodiment.

FIG. 4 is a flowchart showing an example of a processing procedure of the interactive processing system 1 according to the embodiment.

FIG. 5 is a flowchart showing an example of a processing procedure for generating a response text by the interactive processing system 1 according to the embodiment.

FIG. 6 is a flowchart showing an example of a processing procedure for controlling an avatar by the interactive processing system 1 according to an embodiment.

### DETAILED DESCRIPTION

With reference to the drawings, an interactive processing system, an interactive processing method, an interactive processing device, and a program to which the present disclosure is applied will be described below.

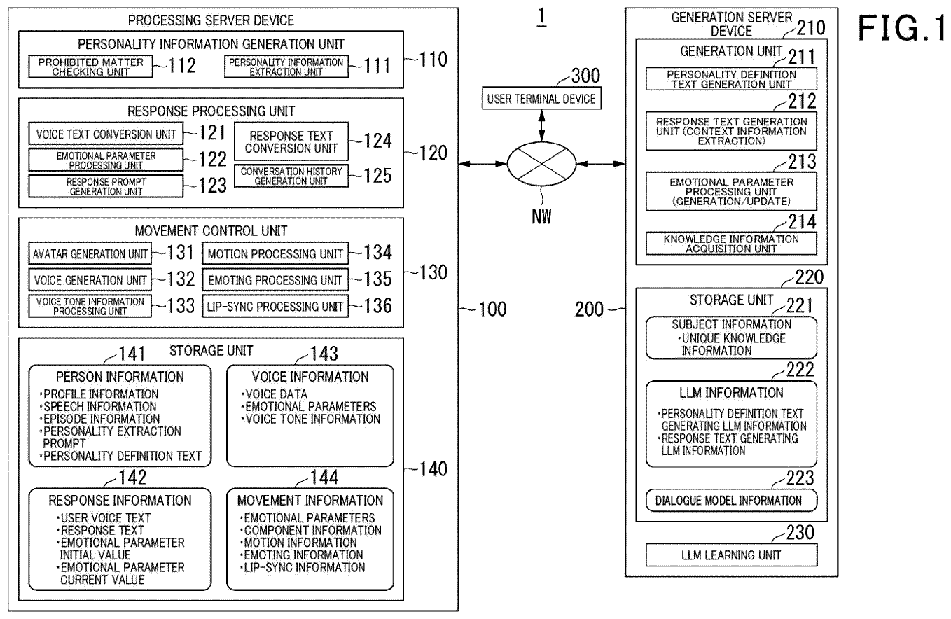

FIG. 1 is a block diagram illustrating a configuration example of an interactive processing system 1 according to an embodiment.

The interactive processing system 1 of the embodiment provides an interactive avatar that operates by considering the personality and dialogue content of a specific person. For example, the interactive processing system 1 can set a specific person as a subject, use the information on the subject's personality, knowledge, voice, appearance, episodes, past statements, profile, and the like to control an avatar of the subject, and provide a content provision service that makes it seem as if the subject and the user are having a conversation.

The interactive processing system 1 may include, for example, a processing server device 100, a generation server device 200 and a user terminal device 300. The processing server device 100, the generation server device 200 and the user terminal device 300 are communicably connected to each other via a network NW such as the Internet. Further, each of the processing server device 100, the generation server device 200 and the user terminal device 300 may be connected via either wired or wireless communication, and may include a general-purpose network such as the Internet and a private network such as local 5G or Wi-Fi (registered trademark). The processing server device 100, the generation server device 200 and the user terminal device 300 may have a communication interface such as a NIC (Network Interface Card) or a wireless communication module for connecting to a network, and may exchange information with each other.

The user terminal device 300 may be, for example, an information processing device operated by a user interacting with an avatar. The user terminal device 300 may include, for example, a speaker, a microphone, a display device, an operation unit, a processing unit such as a CPU, and the like.

The processing server device 100 is a server device that may include, for example, a processor that performs processing in response to a request received from the generation server device 200 and the user terminal device 300 and transmits the processing results to the processing server device 100. The processing server device 100 may include, for example, a personality information generation unit 110, a response processing unit 120, a movement control unit 130 and a storage unit 140. The personality information generation unit 110, the response processing unit 120 and the movement control unit 130 are functional units that may be implemented by, for example, an information processing circuit that performs various processes by causing a CPU (Central Processing Unit) to execute a program. Further, some or all of the functional units may be implemented by hardware such as an LSI (Large Scale Integration), ASIC (Application Specific Integrated Circuit) or FPGA (Field-Programmable Gate Array) or may be implemented through the cooperation of software and hardware. The storage unit 140 may be implemented by, for example, an HDD (Hard Disk Drive), an SSD (Solid State Drive), a flash memory, an EEPROM (Electrically Erasable Programmable Read Only Memory), a ROM (Read Only Memory), a RAM (Random Access Memory) or a hybrid storage device that uses a plurality of these devices. Some or all of the storage unit 140 may be implemented by an external storage device accessible via various networks. Examples of the external storage device include a NAS (Network Attached Storage) device.

The personality information generation unit 110 supplies a plurality of personality factor parameters which influence the personality of the subject, and generates personality definition text information indicating the personality of the subject. The personality information generation unit 110 may include, for example, a personality information extraction unit 111 and a prohibited matter checking unit 112.

The personality information extraction unit 111 collects information on the subject from an external device such as a terminal device of a service provider or an information providing server device connected via the communication network NW. The personality information extraction unit 111 extracts, from the collected information, the subject's profile information, utterance information, conversation history, SNS information posted by the subject, episode information, and the like as the person information of the subject. The personality information extraction unit 111 generates a personality extraction prompt using the various extracted information. The personality extraction prompt is text data including information such as the personality of the subject.

The personality information generation unit 110 receives a plurality of personality factor parameters from, for example, a terminal device of a service provider or a terminal device related to the subject. The plurality of personality factor parameters are parameters indicating factors that represent the personality of the subject. The factors that represent the personality of the subject may include, for example, neuroticism, extroversion, openness, sincerity and cooperativeness, and the parameters are numerical values indicating the degree of these factors. The personality information generation unit 110 includes the plurality of personality factor parameters in the personality extraction prompt. The personality information generation unit 110 transmits the personality extraction prompt to the generation server device 200, and acquires a personality definition text from the generation server device 200.

The prohibited matter checking unit 112 checks whether the personality definition text information includes prohibited matter. Prohibited matters may include, for example, information that is not allowed to be leaked to the subject and information that is contrary to public order and morals. Information that is contrary to public order and morals may include, for example, information that is contrary to public order and morals particular to a specific country. If the personality definition text information includes prohibited matter, the prohibited matter checking unit 112 adds the prohibited matter included in the personality definition text to a list.

The response processing unit 120 performs processing related to a response to be output to the user terminal device 300 in a conversation between the user and the avatar of the subject. The response processing unit 120 may include, for example, a voice text conversion unit 121, an emotional parameter processing unit 122, a response prompt generation unit 123, a response text conversion unit 124 and a conversation history generation unit 125.

The voice text conversion unit 121 converts the user's voice supplied from the user terminal device 300 into text data.

The emotional parameter processing unit 122 performs processing to set and update emotional parameters. The emotional parameters are numerical values indicating the emotion of the avatar. The emotional parameters may be, for example, information that expresses emotions such as joy, anger, sadness, fun, confidence, confusion and fear on a five-point scale from 1 to 5.

The response prompt generation unit 123 generates a response prompt including the text data of the user's voice, the personality definition text and the emotional parameters, and transmits the generated response prompt to the generation server device 200.

The response text conversion unit 124 converts the response text acquired from the generation server device 200 into voice data.

The conversation history generation unit 125 generates a conversation history between the user and the avatar of the subject.

The response processing unit 120 may generate response text information that reflects a speaking style particular to a specific country based on information indicating the specific country included in the profile information of the subject. The specific country may be the nationality, country of origin, region or the like of the subject included in the profile information stored in the storage unit 140. Further, a specific country may be replaced with a specific region such as North America, South America, Africa, Europe, Asia or Oceania. The response prompt generation unit 123 may include, in the response prompt, text data corresponding to a speaking style and culture of a specific country, for example. Further, the response prompt generation unit 123 may generate a response prompt that includes information, as response content, such as voice timbre, pitch and tone reflecting a speaking style and culture particular to a specific country. Thus, the response processing unit 120 performs processing so that the response reflects the speaking style and culture particular to the specific country.

Furthermore, the response processing unit 120 may generate response text information in a language corresponding to a specific country and a language corresponding to a country other than the specific country based on information indicating a plurality of countries including the specific country included in the profile information of the subject. The response prompt generation unit 123 may include, in the response prompt, for example, text data indicating that the subject speaks in a language of a specific country and a language of a country other than the specific country (multiple languages). Thus, the response processing unit 120 can generate a response text spoken by the subject in multiple languages. Furthermore, the response processing unit 120 can generate response text information reflecting a speaking style particular to a specific country and a speaking style particular to a country other than the specific country.

The movement control unit 130 performs processing to control the movement of the avatar of the subject. The movement control unit 130 may include, for example, an avatar generation unit 131, a voice generation unit 132, a voice tone information processing unit 133, a motion processing unit 134, an emoting processing unit 135 and a lip-sync processing unit 136.

The avatar generation unit 131 generates an avatar of the subject. The avatar generation unit 131 generates component information representing the content for displaying the avatar based on, for example, an image showing the appearance of the subject, and edits the content based on the operation on the terminal device of the service provider.

The voice generation unit 132 generates voice data based on the response text. The voice generation unit 132 may generate, for example, voice data that reproduces reading aloud by the subject's actual voice.

The voice tone information processing unit 133 processes the voice data based on the voice tone information corresponding to the emotional parameters.

The motion processing unit 134 controls the motion of the avatar of the subject based on the emotional parameters and the content of the response text. The motion of the avatar of the subject may represent, for example, the movement of the entire avatar or the movement of the avatar's hand.

The emoting processing unit 135 controls the facial expression of the avatar of the subject based on the emotional parameters and the content of the response text. The emoting processing unit 135 may control, for example, the movement of the avatar's eyes, eyebrows, mouth, and the like.

The lip-sync processing unit 136 controls the movement of the avatar's lips based on the emotional parameters and the content of the response text.

The storage unit 140 may store, for example, person information 141, response information 142, voice information 143 and movement information 144. The person information 141 may include, for example, profile information, utterance information, episode information, a personality extraction prompt and a personality definition text. The response information 142 may include, for example, a user voice text, a response text, an emotional parameter initial value, and an emotional parameter current value. The voice information 143 may include, for example, voice data such as user voice and response voice, emotional parameters and voice tone information. The movement information 144 may include, for example, emotional parameters, component information, motion information, emoting information and lip-sync information. The motion information is a default value representing the motion of the avatar, the emoting information is a default value representing the avatar's emoting, and the lip-sync information is a default value representing the lip-sync of the avatar.

The movement control unit 130 may control the movement of the avatar of the subject to make the movement particular to a specific country based on information indicating the specific country included in the profile information of the subject. The movement control unit 130 controls the movement of the avatar so that it may reflect, for example, gestures, hand gestures and culture particular to a specific country. The movement control unit 130 may cause, for example, the avatar generation unit 131 to generate an avatar with an appearance that matches the nationality or country of origin of the subject. Further, the voice generation unit 132 may generate voice data according to the nationality or country of origin of the subject. Furthermore, the motion processing unit 134 may control the movement of the entire avatar and the movement of the hands of the avatar according to the nationality or country of origin of the subject. Furthermore, the emoting processing unit 135 may control the movement of the avatar's eyes, eyebrows, mouth, and the like according to the nationality or country of origin of the subject. The lip-sync processing unit 136 may control the movement of the avatar's lips according to the nationality or country of origin of the subject.

The generation server device 200 is a server device that may perform processing, for example, in response to a request received from the processing server device 100 and transmit the processing results. The generation server device 200 may include, for example, a generation unit 210, a storage unit 220 and an LLM learning unit 230. The generation unit 210 and the LLM learning unit 230 are functional units that may be implemented by, for example, an information processing circuit that performs various processed by causing a CPU to execute a program. The storage unit 220 may be implemented by, for example, a recording device such as HDD or SSD or a hybrid storage device that uses a plurality of these devices, or may be implemented by an external storage device accessible via various networks such as a NAS device.

The generation unit 210 may include, for example, a personality definition text generation unit 211, a response text generation unit 212, an emotional parameter processing unit 213 and a knowledge information acquisition unit 214.

The personality definition text generation unit 211 supplies a personality extraction prompt acquired from the processing server device 100 to a first language model, and generates personality definition text information based on the output of the first language model.

The response text generation unit 212 generates a response text from the response prompt (including the personality definition text and the voice text) generated by the response prompt generation unit 123, the conversation history with the user generated by the conversation history generation unit 125, and context information acquired by the knowledge information acquisition unit 214. The response text generation unit 212 may supply, for example, the response prompt, the conversation history with the user and the context information to a second language model, and generate a response text based on the second language model. The first language model may be, for example, a large language model (LLM) using a neural network. The second language model is a different LLM from the first language model.

The emotional parameter processing unit 213 generates or updates emotional parameters according to the content of the generated response text. The knowledge information acquisition unit 214 analyzes knowledge information indicating the unique knowledge possessed by the subject, and generates knowledge information of the subject.

The storage unit 220 may include, for example, subject information 221, LLM information 222 and dialogue AI model information 223.

The subject information 221 is a database that associates the subject and knowledge information of the subject. The knowledge information is not limited to the knowledge possessed by the subject, and may supplement necessary knowledge. Further, the knowledge information may be knowledge necessary according to the role of the subject or the purpose of the user. For example, the knowledge information may include product information and customer information necessary for various purposes, such as installation location of the user terminal device 300, product sales by the subject, and conducting training.

The LLM information 222 includes parameter information of an LLM for generating a personality definition text (first language model) and parameter information of an LLM for generating a response text (second language model).

The dialogue AI model information 223 includes parameter information of a dialogue AI model that supplies a response prompt and knowledge information and outputs dialogue information.

The LLM learning unit 230 performs learning for an LLM for generating a personality definition text (first language model) and an LLM for generating a response text (second language model).

Further, when the response prompt generated by the response prompt generation unit 123 includes text data corresponding to a speaking style and culture of a specific country, the response text generation unit 212 generates a response text that reflects the speaking style and culture of the specific country. The second language model can learn, for example, information specifying a specific country, a conversation history with the user, context information and a response text, and output a response text that reflects the speaking style of the specific country when information specifying the specific country is supplied.

Speaking style and pitch of voice may differ from country to country due to difference in the number of vowels. Further, for example, the timing at which speaking speed increases or decreases, the timing at which speech volume (intonation) increases or decreases, the timing at which speech becomes clear or unclear, and the like may differ depending on the culture of the country and the topic. By including such characteristics of the speaking style of a specific country in the response prompt, the response text generation unit 212 can reflect the difference in speaking style for each specific country to the response text.

In the interactive processing system 1 according to the embodiment, as shown in FIG. 1, the functional configurations (functional units) are distributed to the processing server device 100 and the generation server device 200, but the disclosure is not limited thereto, and the functional units may be distributed in other configurations, the functional units of the processing server device 100 and the generation server device 200 may be consolidated into a single device, a plurality of functional units may be consolidated into a single functional unit, or a single function may be distributed to a plurality of functional units.

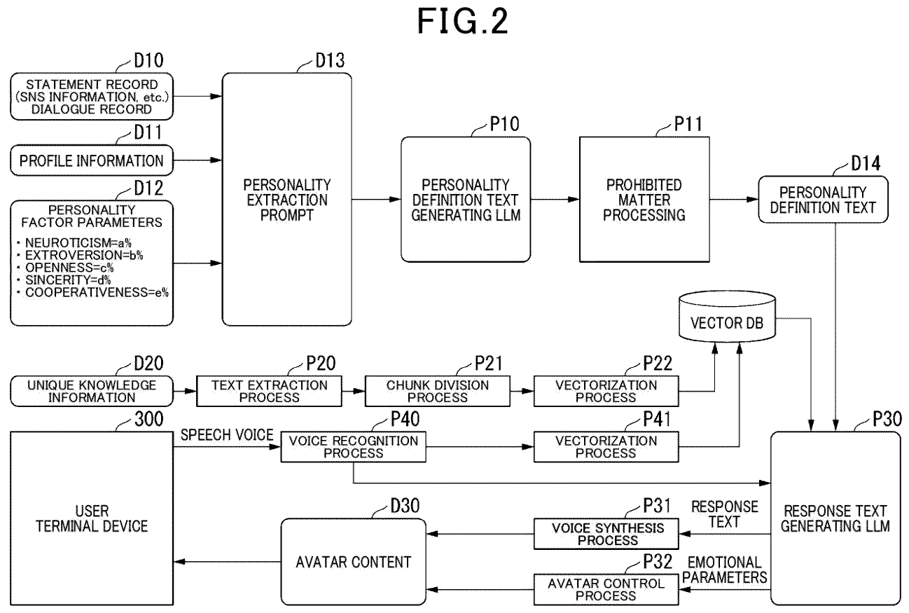

FIG. 2 is a diagram illustrating an outline of processing performed by the interactive processing system 1 according to the embodiment.

The processing server device 100 acquires the subject's statement record and dialogue record D10, profile information D11 and personality factor parameters D12 from an external device, and generates a personality extraction prompt D13 based on the acquired information D10, D11 and D12. The processing server device 100 transmits the personality extraction prompt D13 to the generation server device 200, and the generation server device 200 supplies the personality extraction prompt D13 to a personality definition text generating LLM (P10) and performs prohibited matter processing P11 on the output from the personality definition text generating LLM (P10). The personality definition text D14 to which the command sentence defining the prohibited matter is added by the prohibited matter processing P11 is output to a response text generating LLM.

The generation server device 200 acquires the subject's unique knowledge information D20, performs a text extraction process P20, a chunk division process P21 and a vectorization process P22 in this order on the unique knowledge information D20, and stores vectors corresponding to the unique knowledge information D20 in a vector database. The processing server device 100 performs a voice recognition process P40 on the user's speech voice acquired from the user terminal device 300, performs a vectorization process P41 on the text information processed by the voice recognition process P40, and extracts a reference result from the vector database using a vector corresponding to the speech voice as a query. The vectorized unique knowledge information D20 and the text information processed by the voice recognition process P40 are output to the response text generating LLM (P30) together with the personality definition text D14.

The generation server device 200 supplies the personality definition text D14, the unique knowledge information D20 and the text information processed by the voice recognition process P40 to the response text generating LLM (P30), performs a voice synthesis process P31 on the response text output from the response text generating LLM (P30), and performs an avatar control process P32 based on the emotional parameters output from the response text generating LLM (P30), thereby transmitting avatar content D30 to the user terminal device 300. Thus, the user terminal device 300 can perform display or audio output using the avatar content D30.

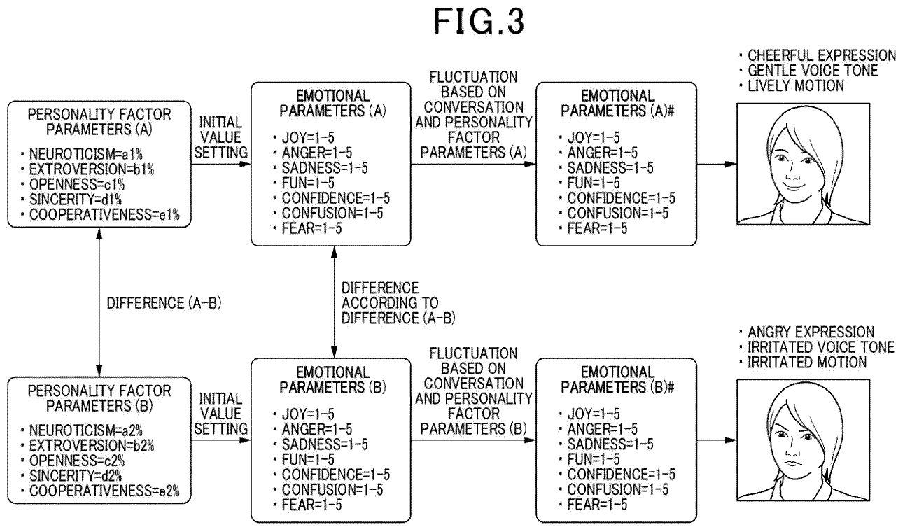

FIG. 3 is a diagram illustrating an example of processing performed on emotional parameters by the interactive processing system 1 according to the embodiment.

Initial values (a1 [%], b1 [%], c1 [%], d1 [%], e1 [%]) of emotional parameters (A) of a subject A are set based on personality factor parameters (A) of the subject A. Initial values (a2 [%], b2 [%], c2 [%], d2 [%], e2 [%]) of emotional parameters (B) of a subject B are set based on personality factor parameters (B) of the subject B. There is a difference (A−B) between the personality factor parameter (A) and the personality factor parameter (B), and a difference occurs between the initial value of the emotional parameter (A) and the initial value of the emotional parameter (B) according to the difference (A−B). According to the difference (A−B) between the personality factor parameter (A) and the personality factor parameter (B), a difference occurs between the fluctuation range (or fluctuation rate) of the emotional parameter (A) and the fluctuation range (or fluctuation rate) of the emotional parameter (B). The processing server device 100 controls the movement of the avatar of the subject A based on the emotional parameters (A), and controls the movement of the avatar of the subject B based on the emotional parameters (B).

The initial values of the emotional parameters (A) fluctuate to emotional parameters (A)# based on the content of the conversation between the user and the avatar, and the personality factor parameters (A). The initial values of the emotional parameters (B) fluctuate to emotional parameters (B)# based on the content of the conversation between the user and the avatar, and the personality factor parameters (B). The generation server device 200 may adjust the fluctuation ranges of the emotional parameters (A)# based on the response text information between the user and the avatar of the subject A, and a plurality of personality factor parameters (A), and may adjust the fluctuation ranges of the emotional parameters (B)# based on the response text information between the user and the avatar of the subject B, and a plurality of personality factor parameters (B).

Thus, the processing server device 100 can change the voice data of the avatar and the movement of the avatar based on the emotional parameters that have changed based on the personality of the subject. For example, based on the emotional parameters (A), the emoting information of the avatar of the subject A can be adjusted to have a cheerful expression, the voice tone information can be adjusted to have a gentle voice tone, and the motion information can be adjusted to have a lively motion. For example, based on the emotional parameters (B), the emoting information of the avatar of the subject B can be adjusted to have an angry expression, the voice tone information can be adjusted to have an irritated voice tone, and the motion information can be adjusted to have an irritated motion.

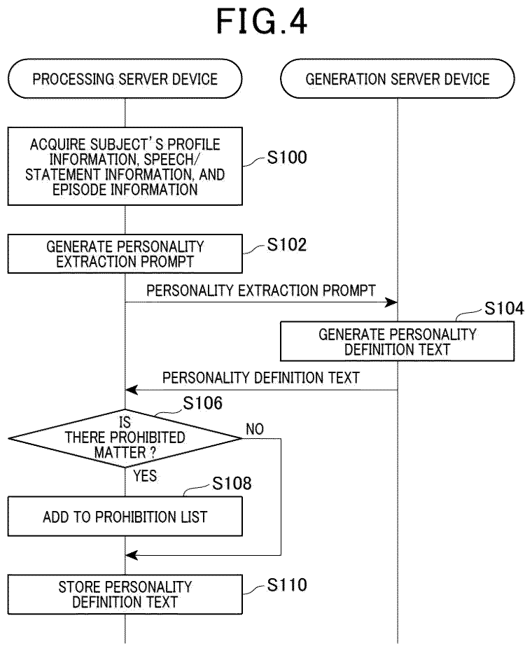

FIG. 4 is a flowchart showing an example of a processing procedure of the interactive processing system 1 according to the embodiment.

First, the processing server device 100 acquires the subject's profile information, utterance information, statement information, episode information, and the like (step S100). The profile information may be, for example, text information such as the subject's name, age, nationality, country of origin, occupation, family structure, social status, medical history and physical characteristics. The utterance information and statement information may be, for example, text information such as the subject's statements and conversation information, the subject's SNS post information, article information featuring the subject, text information transcribed from the voice data or video data. The episode information is text information representing the subject's past experiences, behavior, and the like. The subject may be a real person or a fictional person. If the subject is a fictional person, all the profile information, utterance information, and the like may be fictional information, or a part thereof may be information of a real person or a person who has already passed away.

Next, the processing server device 100 generates a personality extraction prompt based on the information acquired in step S100, and transmits it to the generation server device 200 (step S102). The personality extraction prompt is text information including a plurality of personality factor parameters of the subject. The personality extraction prompt may include information representing the subject's personality, factors that determine behavior, factors that avoid behavior, and information representing the subject's character, and may be, for example, information such as the subject′ questionnaire results or diagnosis results. The processing server device 100 may use a machine learning model that can supply information representing the subject's character and output personality factor parameters.

The generation server device 200 supplies the personality extraction prompt acquired from the processing server device 100 to the personality definition text generating LLM and generates a personality definition text (step S104). The generation server device 200 transmits the generated personality definition text to the processing server device 100.

The processing server device 100 determines whether there is prohibited matter in the personality definition text acquired from the generation server device 200 (step S106), and if there is any prohibited matter in the personality definition text, adds the prohibited matter to a list (step S106: YES and step S108). Thus, the generation server device 200 can add specific actions or statements as prohibited matters to the personality definition text. The processing server device 100 stores the personality definition text in the storage unit 140 (step S110).

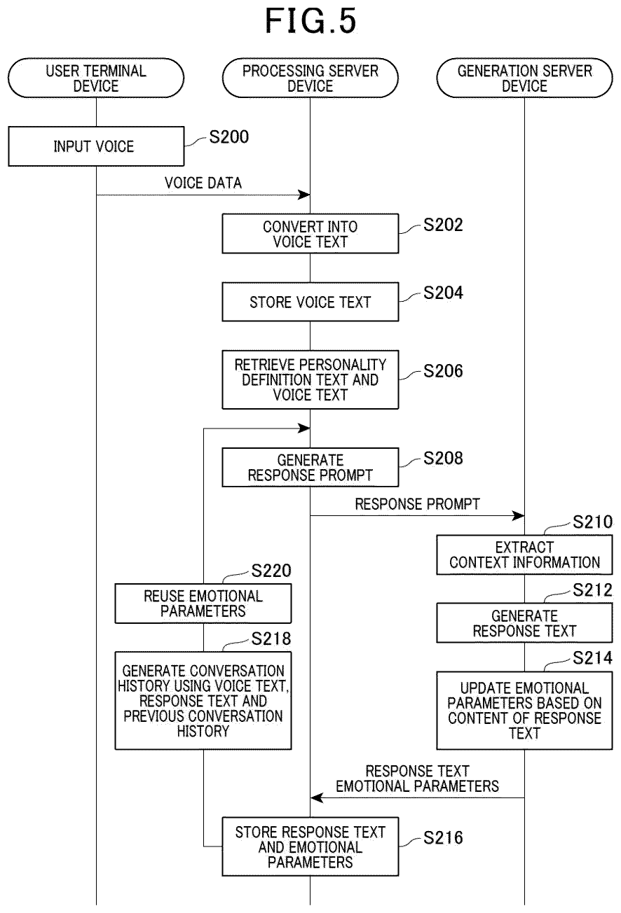

FIG. 5 is a flowchart showing an example of a processing procedure for generating a response text by the interactive processing system 1 according to the embodiment.

The user terminal device 300 transmits voice data to the processing server device 100 in response to the user's voice being supplied (step S200). The processing server device 100 converts the voice data into a voice text (step S202), and stores the voice text (step S204). The processing server device 100 retrieves the personality definition text and the voice text (step S206), generates a response prompt (step S208), and transmits the response prompt to the generation server device 200. The response prompt includes personality factor parameters and personality definition text including prohibited matters, voice text, and current values of emotional parameters.

Upon acquiring the response prompt, the generation server device 200 extracts context information from the voice text by referring the subject's knowledge information (step S210), and generates a response text based on the personality definition text, the voice text, the context information and the conversation history (step S212). The generation server device 200 generates a response text so as not to include the prohibited matters included in the personality definition text. The generation server device 200 updates the emotional parameters based on the content of the generated response text (step S214), and transmits the response text and the emotional parameters to the processing server device 100.

The processing server device 100 stores the response text and the emotional parameters acquired from the generation server device 200 (step S216), generates a conversation history using the previous conversation history, the voice text and the response text (step S218), and stores the stored emotional parameters as information to be reused (step S220).

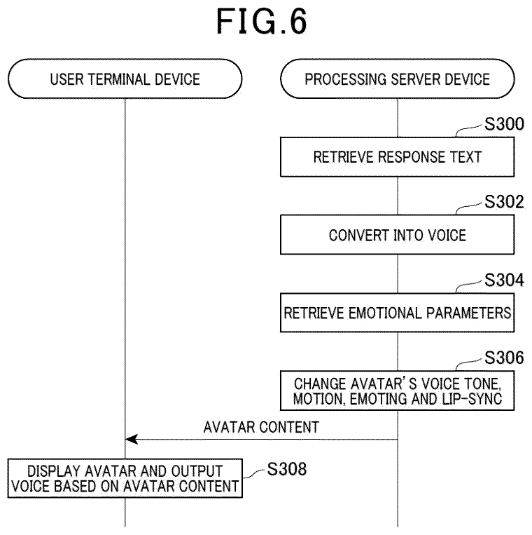

FIG. 6 is a flowchart showing an example of a processing procedure for controlling an avatar by the interactive processing system 1 according to an embodiment.

First, the processing server device 100 retrieves the stored response text (step S300), and converts the response text into voice data (step S302). The processing server device 100 retrieves the stored emotional parameters (step S304), and changes the avatar's voice tone, motion, emoting and lip-sync based on the emotional parameters (step S306). The processing server device 100 transmits the avatar content that reflects the changed voice tone, motion, emoting and lip-sync to the user terminal device 300. The user terminal device 300 receives the avatar content from the processing server device 100, and displays the avatar and outputs the voice based on the avatar content (step S308).

As described above, according to the embodiment, an interactive processing system 1 can be provided which includes: a personality information generation unit (110, 111, 211) that supplies a plurality of personality factor parameters which influence the personality of the subject and generates personality definition text information representing the personality of the subject, and a response processing unit (120) that supplies utterance information received from the user terminal device 300 and the personality definition text information generated by the personality information generation unit and generates response text information. According to the embodiment, an interactive avatar that operates by considering the personality and dialogue content of a specific person can be provided.

According to the interactive processing system 1 of the embodiment, it is possible to automatically generate a personality extraction prompt obtained by extracting profile information of the subject, utterance or conversation history information of the subject, and the personality factor parameters from information acquired from an external device, and generate personality definition text information based on the generated personality extraction prompt. According to the interactive processing system 1, it is possible to provide an avatar that reproduces the personality of a specific person by adding the personality factor parameters to the information used for the existing avatar.

According to the interactive processing system 1 of the embodiment, since a personality extraction prompt including knowledge information is generated, it is possible to provide an avatar that reproduces the knowledge possessed by a specific person in addition to the personality of the specific person.

According to the interactive processing system 1 of the embodiment, since profile information, utterance or conversation history information and personality factor parameters can be supplied to a first language model and personality definition text information can be generated based on the output of the first language model, it is possible to reduce the effort required to generate a personality definition text.

According to the interactive processing system 1 of the embodiment, since prohibited matter to be excluded from a response text output by the first language model can be extracted, actions or statements that the avatar may perform can be controlled based on the prohibited matters described in the personality definition text.

According to the interactive processing system 1 of the embodiment, since utterance information and personality definition text information can be supplied to a second language model and response text information can be generated based on the output of the second language model, it is possible to change the response content of the avatar by considering the personality factor parameters included in the personality definition text information.

According to the interactive processing system 1 of the embodiment, emotional parameters of an avatar are generated based on the personality definition text information and the response text information. Further, according to the interactive processing system 1 of the embodiment, utterance information, personality definition text information and response text information are supplied to a second language model, and response text information and emotional parameters of an avatar are generated based on the output of the second language model. Thus, according to the interactive processing system 1, it is possible to change the emotions of an avatar by considering the personality factor parameters included in the personality definition text information.

According to the interactive processing system 1 of the embodiment, the response processing unit 120 can generate response text information that reflects a speaking style particular to a specific country based on information indicating the specific country included in the profile information of the subject. Further, according to the interactive processing system 1 of the embodiment, the movement control unit can control movement of an avatar of the subject to make the movement particular to a specific country based on information indicating the specific country included in the profile information of the subject. Thus, according to the interactive processing system 1, it is possible to provide an avatar that speaks and acts in a manner particular to a specific country by setting the specific country for the subject.

According to the interactive processing system 1 of the embodiment, the response processing unit 120 can generate response text information in a language corresponding to the specific country and a language corresponding to a country other than the specific country based on information indicating a plurality of countries including the specific country included in the profile information of the subject. Thus, according to the interactive processing system 1, it is possible to provide an avatar corresponding to languages of many countries.

According to the interactive processing system 1 of the embodiment, the movement control unit 130 can control movement of an avatar of the subject based on the response text information. Thus, according to the interactive processing system 1, it is possible to control the avatar including the actions of the specific person in addition to the personality and dialogue content of the specific person.

According to the interactive processing system 1 of the embodiment, since initial values of emotional parameters are set based on the plurality of personality factor parameters and the emotional parameters are changed based on the response text information, it is possible to provide an avatar in which the emotional parameters are changed according to the personality of a specific person. Further, according to the interactive processing system 1, since a fluctuation range of the emotional parameters is adjusted based on the response text information and the plurality of personality factor parameters, it is possible to change the emotions according to the personality of a specific person. Further, according to the interactive processing system 1, since the voice data of the avatar and the movement of the avatar are changed based on the emotional parameters, it is possible to provide an avatar corresponding to the personality of a specific person.

The functions of the processing server device 100, the generation server device 200, and the user terminal device 300 in the above-mentioned embodiment may be implemented by a computer. In this case, programs for implementing the functions may be recorded on a computer-readable recording medium, and the programs recorded on the recording medium may be read and executed by a computer system. The “computer system” herein includes an OS and hardware such as peripheral devices. The “computer-readable recording medium” refers to a storage device, such as a portable medium such as a flexible disk, a magneto-optical disk, a ROM or a CD-ROM, or a hard disk incorporated in a computer system. The “computer-readable recording medium” may also include a recording medium dynamically holding a program for a short period of time, such as a communication line in the case of transmitting the program via a network such as the Internet or a communication channel such as a telephone line, and a recording medium holding a program for a certain period of time, such as a volatile memory in a computer system serving as a server or a client in the above case. The above programs may be programs for implementing some of the functions described above, or may be programs that can implement the functions described above in combination with programs already recorded in a computer system, or may be programs implemented using a programmable logic device such as an FPGA (Field Programmable Gate Array).

Although each of the embodiments and modified examples have been described, these are merely examples and the present disclosure is not limited thereto. For example, an aspect of the present disclosure may be achieved by combining any of the embodiments or modified examples or a part of the embodiments or modified examples with one or more other embodiments or one or more other modified examples.

### REFERENCE SIGNS LIST

1 . . . Interactive processing system,
100 . . . Processing server device,
110 . . . Personality information generation unit,
111 . . . Personality information extraction unit,
112 . . . Prohibited matter checking unit,
120 . . . Response processing unit,
121 . . . Voice text conversion unit,
122 . . . Emotional parameter processing unit,
123 . . . Response prompt generation unit,
124 . . . Response text conversion unit,
125 . . . Conversation history generation unit,
130 . . . Movement control unit,
131 . . . Avatar generation unit,
132 . . . Voice generation unit,
133 . . . Voice tone information processing unit,
134 . . . Motion processing unit,
135 . . . Emoting processing unit,
136 . . . Lip-sync processing unit,
140 . . . Storage unit,
141 . . . Person information,
142 . . . Response information,
143 . . . Voice information,
144 . . . Movement information,
200 . . . Generation server device,
210 . . . Generation unit,
211 . . . Personality definition text generation unit,
212 . . . Response text generation unit,
213 . . . Emotional parameter processing unit,
214 . . . Knowledge information acquisition unit,
220 . . . Storage unit,
221 . . . Subject information,
222 . . . LLM information,
223 . . . Dialogue AI model information,
230 . . . LLM learning unit,
300 . . . User terminal device

1. An interactive processing system, comprising:
circuitry configured to
receive a request from a user terminal,
in response to the request from the user terminal
generate personality definition text information representing the personality of a subject based on a plurality of personality factor parameters which influence the personality of the subject, and
generate response text information based on utterance information received from the user terminal and the personality definition text information.

2. The interactive processing system according to claim 1, wherein the circuitry is further configured to
generate a personality extraction prompt obtained by extracting profile information of the subject, utterance or conversation history information of the subject, and the personality factor parameters from information acquired from an external device, and
generate the personality definition text information based on the generated personality extraction prompt.

3. The interactive processing system according to claim 2, wherein the circuitry is further configured to
acquire knowledge information indicating unique knowledge possessed by the subject, and
generate the personality extraction prompt including the acquired knowledge information.

4. The interactive processing system according to claim 1, wherein the circuitry is further configured to
supply the profile information of the subject, the utterance or conversation history information of the subject, and the plurality of personality factor parameters to a first language model, and
generate the personality definition text information based on an output of the first language model.

5. The interactive processing system according to claim 4, wherein the circuitry is further configured to
extract prohibited matter to be excluded from a response text output by the first language model.

6. The interactive processing system according to claim 1, wherein the circuitry is further configured to
supply the utterance information and the personality definition text information to a second language model, and
generate the response text information based on an output of the second language model.

7. The interactive processing system according to claim 1, wherein the circuitry is further configured to
generate emotional parameters of an avatar based on the personality definition text information and the response text information.

8. The interactive processing system according to claim 6, wherein the circuitry is further configured to
supply the utterance information and the personality definition text information to the second language model, and
generate the response text information and emotional parameters of an avatar based on an output of the second language model.

9. The interactive processing system according to claim 1, wherein the circuitry is further configured to
generate the response text information that reflects a speaking style particular to a specific country based on information indicating the specific country included in the profile information of the subject.

10. The interactive processing system according to claim 1, wherein the circuitry is further configured to
generate the response text information in a language corresponding to the specific country and a language corresponding to a country other than the specific country based on information indicating a plurality of countries including the specific country included in the profile information of the subject.

11. The interactive processing system according to claim 1, wherein the circuitry is further configured to
control movement of an avatar of the subject based on the response text information.

12. The interactive processing system according to claim 11, wherein the circuitry is further configured to
set initial values of emotional parameters based on the plurality of personality factor parameters,
change the emotional parameters based on the response text information, and
control movement of an avatar based on the emotional parameters.

13. The interactive processing system according to claim 12, wherein the circuitry is further configured to
adjust a fluctuation range of the emotional parameters based on the response text information and the plurality of personality factor parameters.

14. The interactive processing system according to claim 11, wherein the circuitry is further configured to
generate emotional parameters of an avatar based on the personality definition text information and the response text information, and
change voice data of the avatar and movement of the avatar based on the emotional parameters.

15. The interactive processing system according to claim 11, wherein the processing circuitry is further configured to
control movement of an avatar of the subject to make the movement particular to a specific country based on information indicating the specific country included in the profile information of the subject.

16. An interactive processing method, comprising:
generating personality definition text information representing the personality of a subject based on a plurality of personality factor parameters which influence the personality of the subject; and
generating response text information based on utterance information received from a user terminal device and the personality definition text information.

17. An interactive processing device, comprising:
circuitry configured to
generate personality definition text information representing the personality of a subject based on a plurality of personality factor parameters which influence the personality of the subject, and
generate response text information based on utterance information received from a user terminal device and the personality definition text information.

18. A non-transitory computer-readable storage medium storing computer-readable instructions thereon which, when executed by a computer, cause the computer to perform a method, the method comprising:
generating personality definition text information representing the personality of a subject based on a plurality of personality factor parameters which influence the personality of the subject; and
generating response text information based on utterance information received from a user terminal device and the personality definition text information.
